(19) United States
(12) Patent Application Publication
(10) Pub. No.: US 2013/0156256 A1
(43) Pub. Date: Jun. 20, 2013

(54) STEGANOGRAPHIC ENCODING AND VERIFICATION

(71) Applicant: Travis Nicks, Littleton, CO (US)

(72) Inventor: Travis Nicks, Littleton, CO (US)

(21) Appl. No.: 13/529,189

(22) Filed: Jun. 21, 2012

Related U.S. Application Data
(60) Provisional application No. 61/499,678, filed on Jun. 21, 2011.

(51) Int. Cl. G06K 9/36

(52) U.S. Cl. CPC G06K 9/36
USPC 382/100

(57) ABSTRACT

Multi-Dimensional Statistical Patchwork Steganographic Encoding and Verification uses fluctuations in image density and brightness to encode a binary cipher and decode the same in the absence of prior knowledge other than that of the existence of encoding and encoding party source. Once encoded, the image can be deciphered without any prior knowledge outside the encoding preference or hallmarks. This allows a party to encode and image, release it publicly, retrieve it at a later time, and decode it without any other knowledge than it was an image they encoded. Using a statistical representation of a defined segment of the image in a mated pair is used to define either a “I” or “0”. The addition of stereoscopic, alternate frequency bands, or harmonic stacking allows multiplication of available bits without degradation of image appearance. Using any pre-defined hallmarks of origin and pattern allow for non-cataloged reference of the encoded image.

### RELATED APPLICATIONS

This application claims priority from U.S. provisional patent application Ser. No. 61/499,678 filed Jun. 21, 2011, the disclosure of which is incorporated herein by reference in its entirety.

### BACKGROUND

The present application relates generally to the field of electronic communications and social networked task management and specifically to a method of encoding ciphers within images.

New method of steganography for use in platforms and on the internet in general may be useful to facilitate a more robust, secure, and reliable verification process immune to a majority of user and programatic manipulation. Non-lossless compression, image integrity, image manipulation, and digital-physical-digital image conversion (printing and scanning) all degrade and render inert simpler methods of steganography (such as least significant bit substitution) so a more robust and secure way was needed yet the cipher data capacity required more than standard patchwork steganography provided.

Typically with patchwork steganography the amount of data to be encoded must remain small relative to the amount of data within the target image. This is inversely proportional to the degree of robustness of the resultant encoding. With MDSPE the amount of data encoded can be multiplied by the number of dimensions used for encoding. This removes the limitation of amount of data so that a small image can contain a relatively large amount of encoded data without suffering visible detectable degradation.

### BRIEF DESCRIPTION OF THE DRAWINGS

The invention is now described, by way of non-limiting example, with reference to the accompanying diagrammatic drawings in which like reference numerals are used to indicate the same or similar features.

FIG. 1 shows a schematic representation of a standard RGB8 image matrix.

FIG. 2 shows a flow diagram of the encoding process.

FIG. 3 shows a schematic block diagram of multiple dimension encoding.

FIG. 4 shows a schematic representation of an encoded image.

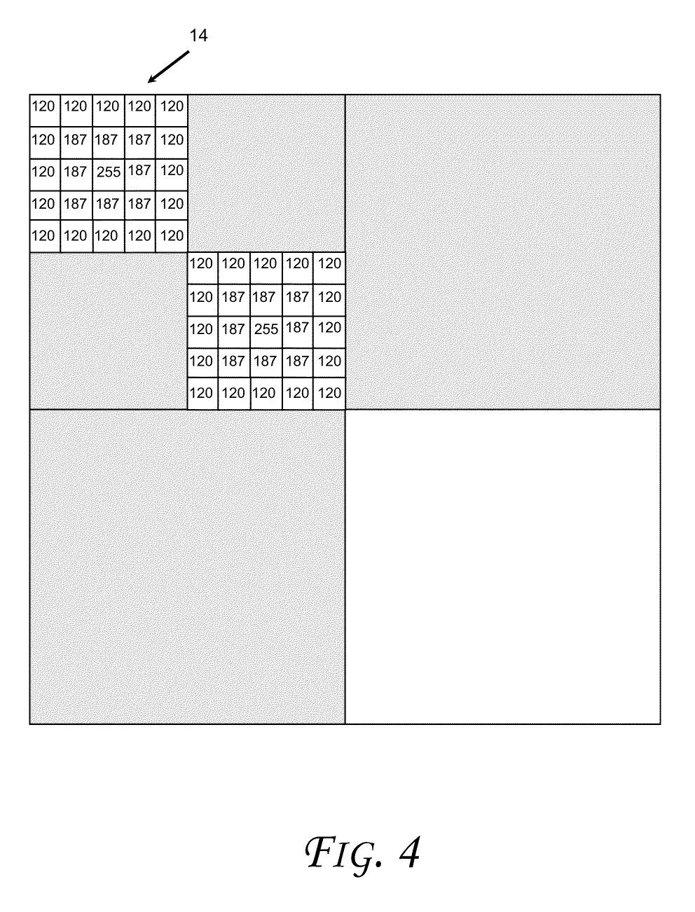

FIG. 5 shows a schematic flow diagram of the decoding algorithm.

FIG. 6 is a schematic illustration of a computing system adapted to implement steganographic encoding and verification, according to embodiments.

### DETAILED DESCRIPTION

Described herein are exemplary systems and methods for the encoding of an image with cipher and decoding the same is described. In the following description, for the purposes of explanation, numerous specific details are set forth in order to provide a thorough understanding of the present invention. It will be evident, however, to one skilled in the are that the present invention may be practiced without these specific details.

The use of RGB8 standard image format is used in the following merely as a reference example. Any method of image processing can be adapted to the MDSPE method.

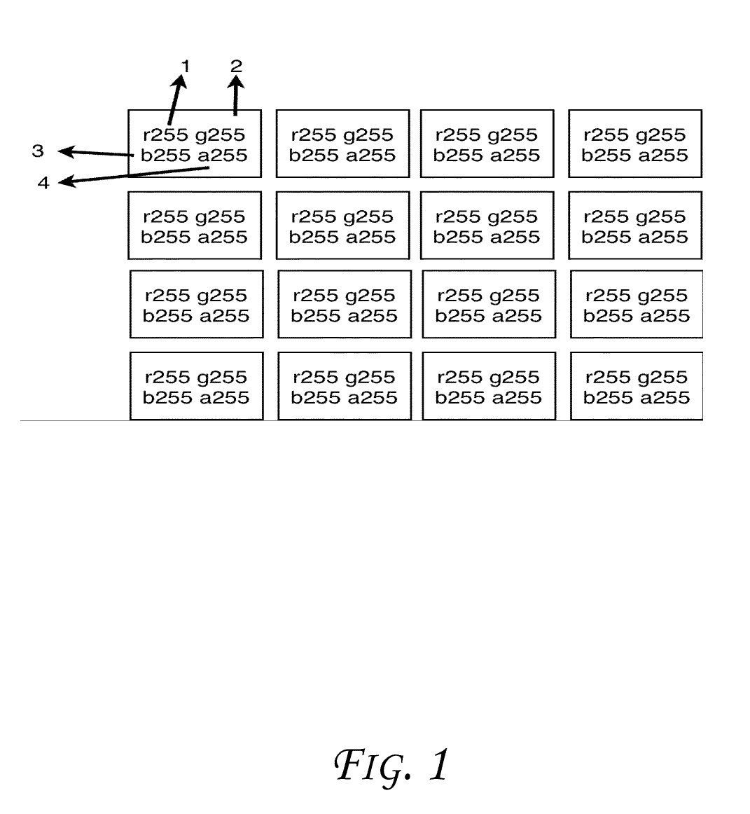

Referring to FIG. 1 a typical image of format RGB8 is made up of four distinct values 1, 2, 3, 4 per pixel. The Red 1, Green 2, Blue 3, and Alpha 4 characteristics of each pixel fall within values between 255 and 0. Any adjustment to one or more of those values in a pixel will alter the statistical “density” of that pixel. Least significant bit steganography uses the lowest value bits of each pixel characteristic to encode a cipher thus causing minimal changes to the appearance of the target image. While this works on images which have not been modified it does not work once an image is compressed, lightened or darkened, printed and scanned, or saved into a different format. The dependence on static pixel values is the reason that small manipulations will destroy any cipher. To solve this, ciphers are repeated many times within an image.

In patchwork steganography a predetermined area of an image 11, 12, 13 is grouped and viewed as a whole for the level of it's intensity or brightness and then compared to a companion group. If the companion is the same intensity then a “0” is marked and if it is different out side a predetermined threshold then a “1” is marked. (This method can be expanded beyond the simple a=b−>“0” to include other pairs and algorithms if desired.) This affords robustness when copying, changing formats, or printing images but requires a large percentage of the image data to encode a small cipher. The limitations are due to the desire for an increase in robust encoding. In order to insure that any manipulation of the image has little to no impact on the cipher large areas and less subtle changes are required.

By taking a patch and applying a gradual statistical adjustment to the intensity of the bits in a concentric 14 or other pattern (such as random) the impact to the visualization of the image is minimal but the changes in overall intensity of the patch when compared to its mated pair counterpart is significant. Since the changes are not equal to all the pixels in a patch a stark contrast is avoided. Since the pixels are taken as a single statistical value and the delta between the patches of the mated pair the encoding is near impervious to all but the most egregious manipulations.

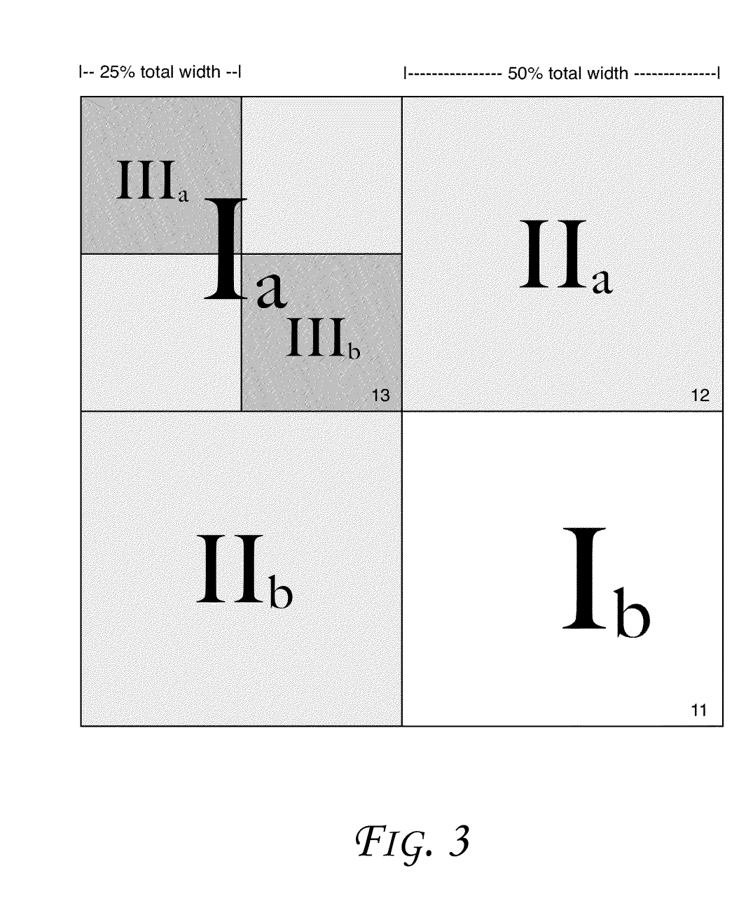

This allows not only for smaller patches but nested patches as demonstrated in FIG. 3. Using a statistical calculation on the patch as a whole and keeping the changes to pixel elements in a concentric 14 of other pattern and not equal, different parts of a larger patch can become new, smaller patches 11, 12, 13. By encoding the cipher at the smallest patch size first and then placing a moratorium on changes to those particular patches while moving up in patch scale a number of dimensional layers can be added. The limits being the size of the target image and the threshold sensitivity.

Encoded images can become robust against resizing by using proportional patch sizes as opposed to static sizes. When encoding a target image, as long as the percentage of width and height, see FIG. 3, are retained with the decoder then a resizing of the encoded image will have no effect on the ability to decode and extract the cipher.

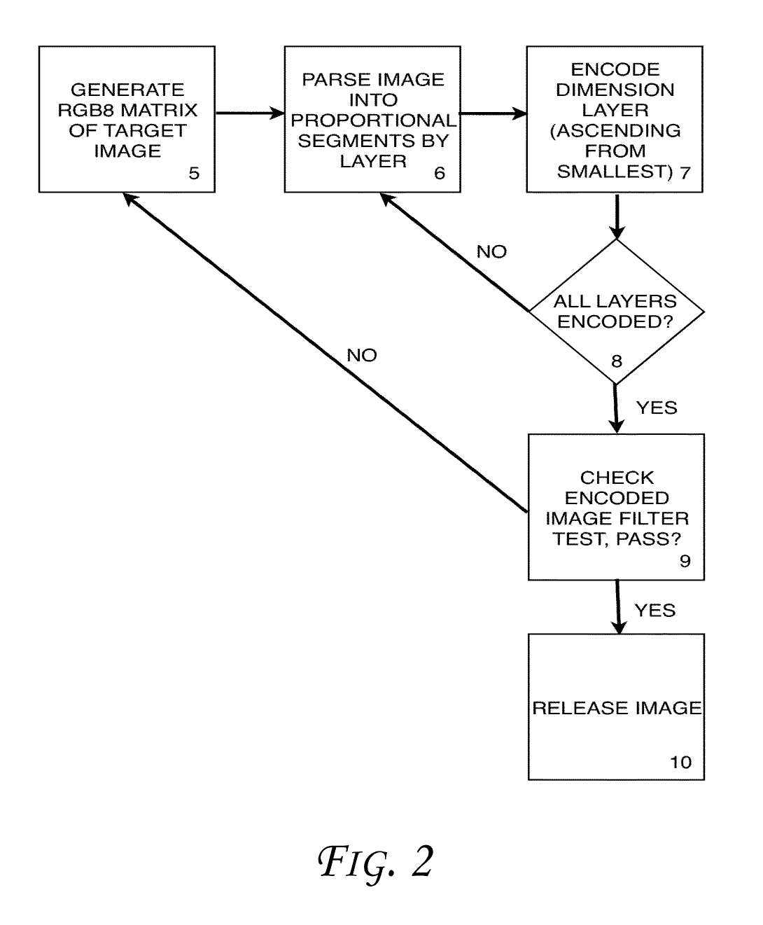

FIG. 2 shows the process which yields a coded image. First taking any image and converting to the desired encoding format 5 (in this case RGB8). Once a matrix is established a segmentation using total image proportions 6 (including width and height for creating a location baseline) is done to set the mated pair patches. The pairs need not be adjacent however the patches in a pair must know the location of each other. Dimension layers can be considered independent of one another or as part of the whole cipher. The exception to this is the largest dimension layer as that is reserved for the decoding hallmarks and key. It is possible to encode each dimensional layer with hallmarks and keys for that and subsequent layers thus increasing the entropy which can be utilized in encoding the cipher. i.e. rectangular or irregular shape patches, overlapping and wholly contained patches, mated pairs of different dimensional layers, etc.

Once all the dimensional layers 7, 8 have been encoded with the cipher, key, and hallmarks the image is put through a simple filter 9 to test visual integrity. This involves simply comparing the total specifications of the original values of the image with the encoded image to see if they fall outside thresholds. If the image passes then it can be released 10.

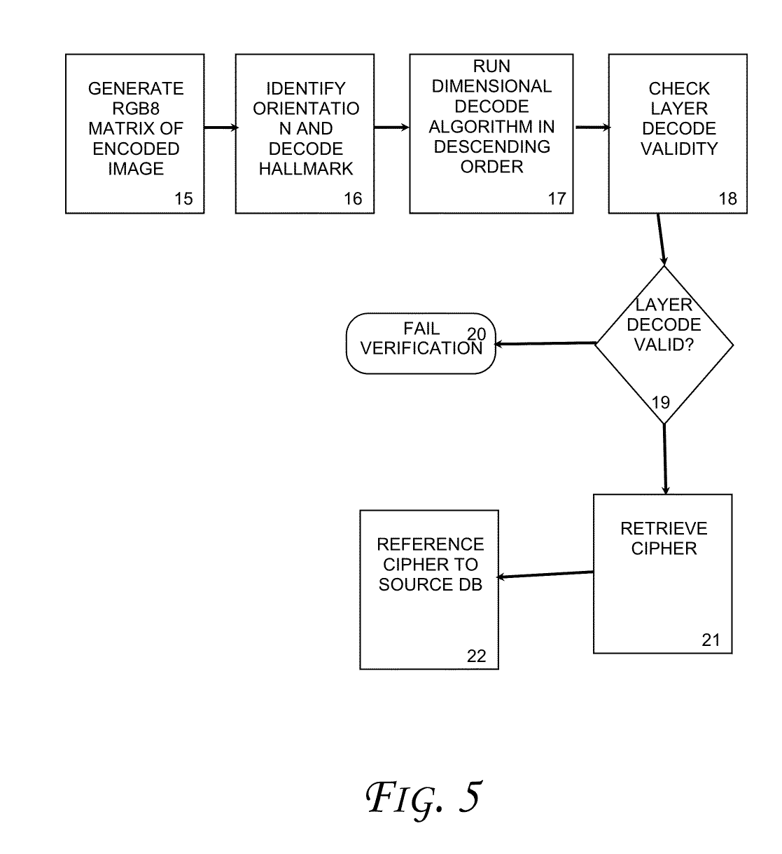

Decoding the image involves reversing the steps in FIG. 2. FIG. 5 shows the flow of the decode algorithm, starting with identifying the hallmarks and key 16. Once retrieved the key and hallmarks are checked against a record of such maintained by the encoding party. The appropriate decode procedure is then executed on all subsequent layers 17. Checks are run on each layer by comparing identified numbers of mated pairs with the proposed number kept in the decode algorithm 18. If at any level the decoded layer does not match the expected number of mated pairs the image is discredited and the cipher discarded as corrupt 19.

The cipher should be hashed or encrypted prior to encoding and then once decoded and be referenced in whatever manner the encoding party wishes to use 21, 22. This provides a further layer of security. Even if the steganography is compromised the cipher is encrypted and relates to only one key.

The specific statistical changes made to a patch can be varied. A formula of brightness is equal to the square root of the sum of (0.241×Red̂2+0.691×Green̂2+0.068×Bluê2) works one a per pixel level (this is a common formula for pixel brightness). When averaged across a patch a representation of an areas brightness can be determined. Compare and set to the mated pair patch and a “1” or “0” can be encoded.

The use of comparative, paired brightness within nested patches across an image provides a unique way to encode a cipher into any image.

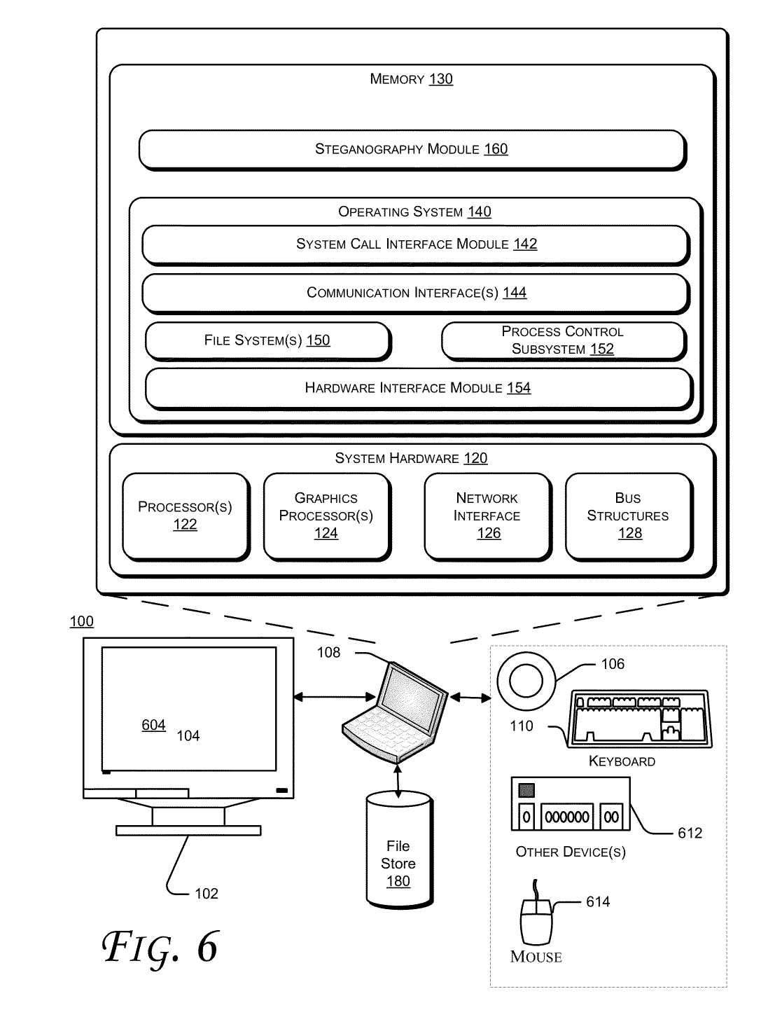

FIG. 6 is a schematic illustration of an exemplary system 100 which may be adapted to implement steganographic encoding and verification in accordance with some embodiments. In one embodiment, system 100 includes an electronic device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, a geolocation device, an accelerometer/gyroscope and any other device that allows the system 100 to receive input from a user.

In various embodiments, the electronic device 108 may be embodied as a personal computer, a laptop computer, a personal digital assistant, a mobile telephone, an entertainment device, or another computing device. The electronic device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated into the packaging of processor(s) 122, onto the motherboard of computing system 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

In some embodiments the operations depicted in the flowcharts of FIGS. 2 and 5 may be implemented by the steganography module(s) 160 of the, alone or in combination with other modules.

Thus, there is described herein an architecture and associated methods to implement steganographic encoding and verification in electronic devices.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

In the description and claims the term steganograph shall refer to the hiding of data within an image. The term patchwork shall refer to the intentional and algorithmic segmentation of a target image for use of steganographic encoding. The term target image (TI) shall refer to any image being used as a vessel for steganographic encoding of a cipher. The term cipher shall refer to the series of bits to be encoded into an image. The term mated pair shall refer to a pair of segments used to identify by comparison the existence of non-existence of an encoded bit. The term encoded bit shall refer to a bit in a cipher that is represented by a difference between the elements of a mated pair. The term patch shall refer to a portion of an image which forms half of a Mated Pair. The term hallmark shall refer to a recognized pattern to direct the decoder on proper orientation and error correction of the image. The term key shall refer to a recognized pattern to indicate which decode algorithm is required. The term dimensional layer shall refer to a set of patch mated pairs are a specific range of proportion to the whole image.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A computer-based method to encode an image, comprising:
converting an image to an encoding format;
parsing the image into proportional segments;
encoding a plurality of dimension layers of the encoded image with a cipher key, beginning with the smallest dimension layer;
comparing a set of specifications of the encoded image with a corresponding set of specifications from of the original image; and
releasing the encoded image when a difference between the set of specifications of the encoded image and the set of specifications from the original image is less than a threshold amount.

2. The computer based method of claim 1, wherein parsing the image into proportional segments comprises assigning mated pair patches, wherein mated pairs are assigned the location of their respective pair.

3. The computer based method of claim 1, wherein the largest dimension layer is reserved for decoding hallmarks and the cipher key.

4. The computer based method of claim 1, wherein dimensional layers are encoded with hallmarks and keys for one or more subsequent dimensional layers.

5. The computer based method of claim 1, further comprising decoding the encoded image.

6. The computer based method of claim 5, wherein decoding the encoded image comprises:
generating a matrix of the encoded image;
identifying an image orientation and decoding a hallmark;
decoding a plurality of dimension layers of the encoded image with a cipher key, beginning with the smallest dimension layer; and
validating each decoded dimension layer.

7. The computer based method of claim 6, further comprising discarding the image as corrupt when a dimension layer cannot be validated.

8. An electronic device, comprising:
a display;
a processor;
logic instructions stored in a tangible computer readable medium which, when executed by the processor, configure the processor to implement operations to encode an image, comprising:
converting an image to an encoding format;
parsing the image into proportional segments;
encoding a plurality of dimension layers of the encoded image with a cipher key, beginning with the smallest dimension layer;
comparing a set of specifications of the encoded image with a corresponding set of specifications from of the original image; and
releasing the encoded image when a difference between the set of specifications of the encoded image and the set of specifications from the original image is less than a threshold amount.

9. The electronic device of claim 8, further comprising logic instructions stored in a tangible computer readable medium which, when executed by the processor, configure the processor to assign mated pair patches, wherein mated pairs are assigned the location of their respective pair.

10. The electronic device of claim 8, wherein the largest dimension layer is reserved for decoding hallmarks and the cipher key.

11. The electronic device of claim 8, wherein dimensional layers are encoded with hallmarks and keys for one or more subsequent dimensional layers.

12. The electronic device of claim 8, further comprising logic instructions stored in a tangible computer readable medium which, when executed by the processor, configure the processor to decode the encoded image.

13. The electronic device of claim 12, further comprising logic instructions stored in a tangible computer readable medium which, when executed by the processor, configure the processor to:
generate a matrix of the encoded image;
identify an image orientation and decoding a hallmark;
decode a plurality of dimension layers of the encoded image with a cipher key, beginning with the smallest dimension layer; and
validate each decoded dimension layer.

14. The electronic device of claim 8, further comprising logic instructions stored in a tangible computer readable medium which, when executed by the processor, configure the processor to discard the image as corrupt when a dimension layer cannot be validated.

15. A computer program product comprising logic instructions stored on a tangible computer readable medium which, when executed by a processor, configure the processor to implement operations to encode an image, comprising:
converting an image to an encoding format;
parsing the image into proportional segments;
encoding a plurality of dimension layers of the encoded image with a cipher key, beginning with the smallest dimension layer;
comparing a set of specifications of the encoded image with a corresponding set of specifications from of the original image; and
releasing the encoded image when a difference between the set of specifications of the encoded image and the set of specifications from the original image is less than a threshold amount.

16. The computer program product of claim 15, further comprising logic instructions stored on a tangible computer readable medium which, when executed by a processor, configure the processor to:
assign mated pair patches, wherein mated pairs are assigned the location of their respective pair.

17. The computer program product of claim 15, wherein the largest dimension layer is reserved for decoding hallmarks and the cipher key.

18. The computer program product of claim 15, wherein dimensional layers are encoded with hallmarks and keys for one or more subsequent dimensional layers.

19. The computer program product of claim 15, further comprising logic instructions stored in a tangible computer readable medium which, when executed by the processor, configure the processor to decode the encoded image.

20. The computer program product of claim 19, further comprising logic instructions stored on a tangible computer readable medium which, when executed by a secure controller, configure the secure controller to:
generate a matrix of the encoded image;
identify an image orientation and decoding a hallmark;
decode a plurality of dimension layers of the encoded image with a cipher key, beginning with the smallest dimension layer; and
validate each decoded dimension layer.
